(19) United States
(12) Patent Application Publication
(10) Pub. No.: US 2025/0162867 A1
(43) Pub. Date: May 22, 2025

(54) HYDROCARBON PYROLYSIS USING SUBMICRON-SIZED HIGH ENTROPY ALLOY CATALYST FOR PRODUCTION OF HYDROGEN

(71) Applicant: SAUDI ARABIAN OIL COMPANY, Dhahran (SA)

(72) Inventors: Xiaoxing WANG, Richmond, TX (US); Feng LIANG, Houston, TX (US)

(73) Assignee: SAUDI ARABIAN OIL COMPANY, Dhahran (SA)

(21) Appl. No.: 18/516,491

(22) Filed: Nov. 21, 2023

(51) Int. Cl. C01B 3/30; C01B 32/05

(52) U.S. Cl. CPC C01B 3/30; C01B 32/05; C01B 2203/1058; C01B 2203/1082; C01B 2203/1235; C01B 2210/001; C01B 2210/007

(57) ABSTRACT

High entropy alloy catalysts may be used for production of hydrogen. An example method of hydrogen production may include: introducing a hydrocarbon to a reactor, wherein the reactor contains therein a catalyst, wherein the reactor is substantially absent of oxygen and water, wherein the catalyst comprises a high entropy alloy and a catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and reacting the hydrocarbon over the catalyst to produce solid carbon and hydrogen gas.

### FIELD OF THE DISCLOSURE

The present disclosure relates generally to production of hydrogen.

### BACKGROUND OF THE DISCLOSURE

Hydrogen is an emerging clean fuel source with potential to power energy storage, electrical production, vehicle propulsion, and other applications. Hydrogen can be converted to usable energy (including electrical energy) with low or no emissions using technologies such as fuel cells, as the product of hydrogen used in fuel cells is water.

Methane (CH₄) derived from natural gas is the current conventional source for hydrogen production. Conventional methods of producing hydrogen include steam methane reforming (SMR), autothermal methane reforming (ATR), and partial oxidation of methane (POM). SMR, ATR, and POM have a primary disadvantage of high CO₂ emissions that negate the clean-burning advantages of using hydrogen as a fuel source. Additional disadvantages of conventional hydrogen production methods include high energy consumption, high cost, low reaction efficiency, low process efficiency, and low stability of catalyst.

Conventional production of hydrogen (including ATR, SMR, and POM) may involve use of conventional catalyst technology. Catalyst efficiency is one of the key issues with efficient hydrogen production. Conventional catalysts may have limited efficiency and limited lifespan due to the compositions of the catalyst, size effects, surface area effects, porosity, defect density, promotor effects, support effects, coordination state of metal in the catalyst, acid-base properties of the catalyst, or any combination thereof.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting example method of the present disclosure may include: introducing a hydrocarbon to a reactor, wherein the reactor contains therein a catalyst, wherein the reactor is substantially absent of oxygen and water, wherein the catalyst comprises a high entropy alloy and a catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and reacting the hydrocarbon over the catalyst to produce solid carbon and hydrogen gas.

A second nonlimiting example method of the present disclosure may include: purging a reactor with an inert gas so as to remove oxygen, water, or a combination thereof, wherein the inert gas comprises nitrogen, argon, or any combination thereof; introducing a hydrocarbon to the reactor, wherein the reactor contains therein a catalyst, wherein the catalyst comprises a high entropy alloy and an aluminum-based catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and reacting the hydrocarbon with the catalyst to produce solid carbon and produced gas, wherein the produced gas comprises hydrogen gas.

A third nonlimiting example method of the present disclosure may include: introducing a hydrocarbon to a reactor, wherein the reactor contains therein a catalyst, wherein the reactor is substantially absent of oxygen and water, wherein the catalyst comprises a high entropy alloy and an aluminum-based catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy consists essentially of iron, cobalt, manganese, nickel, and a) molybdenum, b) copper, or c) molybdenum and copper; and reacting the hydrocarbon over the catalyst to produce solid carbon and hydrogen gas.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a flow chart of a nonlimiting example method for producing hydrogen from a hydrocarbon according to the present disclosure.

FIG. 2 is diagram of a nonlimiting example system for production of hydrogen from a hydrocarbon according to the present disclosure.

FIG. 3 is a graph of methane conversion efficiency for an example according to the present disclosure.

FIG. 4 is a magnified image of an example according to the present disclosure.

FIG. 5 is a graph of methane conversion efficiency for an example according to the present disclosure.

FIG. 6 is a magnified image of an example according to the present disclosure.

FIG. 7 is a graph of methane conversion efficiency for an example according to the present disclosure.

### DETAILED DESCRIPTION

Embodiments of the present disclosure will now be described in detail with reference to the accompanying Figures. Like elements in the various Figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to the production of hydrogen.

The present disclosure provides methods and systems for hydrogen production from hydrocarbons (e.g., methane, crude oil, gasoline, the like) utilizing pyrolysis, wherein little or no carbon dioxide or carbon monoxide is released. Conventional production of hydrogen from hydrocarbons generally releases significant carbon dioxide and/or carbon monoxide. Methods and systems of the present disclosure limit such release through the use of a reactor environment having little or no oxygen or water therein, as, without being bound by theory, such oxygen or water would potentially react to form carbon dioxide and/or carbon monoxide. The present disclosure allows for production of hydrogen from hydrocarbons with low or no greenhouse gas emissions, thus increasing sustainability of the hydrogen produced. In order to undergo said hydrogen production, methods and systems of the present disclosure may include a reactor system with a catalyst therein, the catalyst comprising a high entropy alloy catalyst.

“Catalyst,” “catalytic,” “catalysis,” and grammatical variants thereof, as used herein, refer to a chemical compound (or process of using such a chemical compound) that increases the rate of a chemical reaction without being consumed during the reaction. A catalyst may comprise an active catalyst and additional components such as, for example, a secondary phase, a catalyst support, a catalyst promotor, the like, or any combination thereof.

“High entropy alloy catalyst” as used herein refers to a catalyst that comprises a high entropy alloy. A high entropy alloy catalyst may comprise additional components as described for a catalyst above.

Without being bound by theory, a catalyst of the present disclosure may react with the hydrocarbon according to a pyrolysis reaction, demonstrated in Equation 1, shown below.

$${C}_{n} {H}_{m} \to n C + ( m / 2 ) {H}_{2} \qquad Equation 1$$

where n is greater than or equal to 1 and m is less than or equal to 2n+2. It should be noted that the reaction in Equation 1 is preferably endothermic. As shown, the pyrolysis reaction does not include oxygen or water in the reaction, and does not produce carbon dioxide or carbon monoxide.

As a nonlimiting example, the catalyst may produce hydrogen from methane in absence of both oxygen and water through a pyrolysis reaction, demonstrated in Equation 2, shown

$${CH}_{4} \to C + 2 {H}_{2} \qquad Equation 2$$

Without being bound by theory, the enthalpy of reaction of Equation 2 is about +75 kJ per mole, indicating it is endothermic.

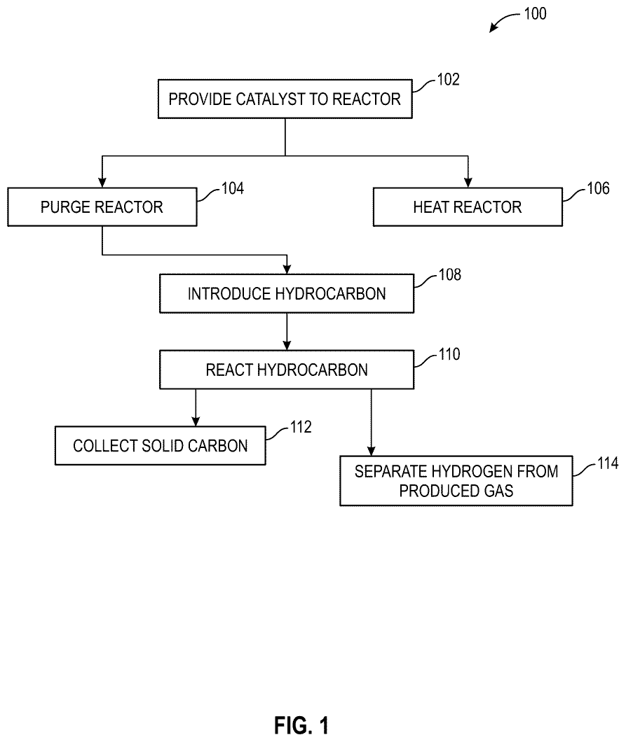

A flow chart of a nonlimiting example method for producing hydrogen from a hydrocarbon according to the present disclosure is shown in FIG. 1. Method 100 includes wherein the catalyst is provided to the reactor (block 102). Following introduction of the catalyst 102, a purge gas may be introduced to the reactor (block 104). While purge gas is being introduced to 104, the reactor may begin to be heated (block 106). It should be noted that heating of the reactor 106 generally occurs during the purging step, and is generally continuous to maintain the heat of the reactor during the reaction process. Following purging 104, a hydrocarbon may be introduced to the reactor (block 108) when the reactor reaches the desired reaction temperature. Introducing the hydrocarbon 108 allows the hydrocarbon to interact in the presence of the catalyst (block 110) and form a product including solid carbon and a produced gas comprising hydrogen. The solid carbon may be separated from the produced gas and collected (block 112), and hydrogen gas may be separated from the produced gas (block 114). Following the separation of hydrogen gas 114, the hydrogen gas may be delivered for further use and/or processing. In some cases, the solid carbon may be continuously removed during the reaction process.

Purging the reactor serves to remove any oxygen or water from the reactor. A purge gas may be used to purge the reactor prior to introducing the hydrocarbon. Examples of a purge gas may include, but are not limited to, nitrogen, argon, the like, or any combination thereof. Purging may occur at any suitable flowrate, and may depend on factors including, but not limited to, the size of the reactor, the geometry of the reactor, the surrounding temperature, the like, or any combination thereof. Purging may occur for a purge time, the purge time being, for example, from 5 min to 5 hours (or 5 min to 3 hours, or 5 min to 90 min, or 10 min to 90 min, or 15 min to 90 min, or 5 min to 60 min, or 10 min to 60 min, or 15 min to 60 min, or 5 min to 30 min, or 10 min to 30 min, or 15 min to 30 min).

The reactor may operate at any suitable temperature and pressure. Preferably the reactor may operate at a temperature from 300° C. to 1200° C. (or 300° C. to 1000° C., or 400° C. to 1000° C., or 400° C. to 900° C., or 500° C. to 900° C., or 500° C. to 800° C., or 600° C. to 800° C., or about 500° C., or about 600° C., or about 700° C., or about 800° C., or 450° C. to 550° C., or 550° C. to 650° C., or 650° C. to 750° C., or 750° C. to 850° C.). Preferably the reactor may operate at a pressure from 1 bar to 25 bar (or 1 bar to 20 bar, or 1 bar to 10 bar, or 5 bar to 15 bar, or 10 bar to 20 bar, or 15 bar to 25 bar, or 0.1 bar to 25 bar). Temperatures and pressures outside the aforementioned ranges are additionally contemplated.

The reactor may output a produced gas. It should be noted that other impurities may be formed in the reactor in addition to the produced gas and the solid carbon and may be intermixed with the produced gas, the solid carbon, or both. The solid carbon may be of any form including, but not limited to, amorphous carbon, carbon nanotubes, nanofibers, graphite, graphene, the like, or any combination thereof. Separating the hydrogen gas and the solid carbon within the produced gas may comprise passing the hydrogen gas through a separation system that may include a solid carbon collection unit, a gas separation unit, or a combination thereof. The solid carbon collection unit may comprise any suitable separation unit including, but not limited to, for example, a cyclonic separation unit in any suitable form, the like, or any combination thereof. The gas separation unit may comprise any suitable gas separation unit including, but not limited to, for example, a separation membrane. A separation membrane may separate the hydrogen gas and the solid carbon, from any impurities, or any combination thereof. Any suitable separation membrane may be used.

Any of the reactors described in any system above may contain a heating system to heat the reactor. The reactor may be heated at any suitable rate, including, but not limited to, for example, a heating rate of from 1° C./min to 30° C./min (or 1° C./min to 20° C./min, or 1° C./min to 15° C./min, or 1° C./min to 10° C./min, or 5° C./min to 10° C./min, or about 5° C./min, or about 10° C./min, or about 15° C./min, or about 20° C./min). The heating system of the reactor may require extensive thermal duty, and thus use of a heating method with low or no greenhouse gas emissions may be preferred, though any suitable heating method may be used. Suitable heating methods for use in the present disclosure may include, but are not limited to, hydrocarbon heating, induction heating, plasma heating (e.g., microwave plasma, the like, or any combination thereof), microwave heating, solar furnace heating, radiant heating, the like, or any combination thereof.

Hydrocarbon heating may comprise burning a hydrocarbon (e.g., natural gas, gasoline, the like, or any combination thereof) in order to provide thermal energy. It should be noted that any suitable heat conduction material (e.g., a heat transfer fluid, the like, or any combination thereof) may be used to convey heat energy from the burning of the hydrocarbon to the reactor.

The heating system may comprise induction heating. In an induction heating system, an electrical current may flow through metal coils to heat metal within the catalyst through electromagnetic induction. Induction heating may increase efficiency of heating by reducing waste heat loss, thus improving the energy efficiency of the reactor.

Plasma heating may comprise a system wherein heat is provided through heating of gases within the reactor to produce plasma. Microwave heating may comprise a system wherein metal coils are used to produce microwave radiation, heating species within the reactor. Solar furnace heating may comprise a system that utilizes thermal energy from solar radiation and conveys the solar radiation thermal energy to the reactor in order to heat the reactor.

For any of the above-described heating methods that require electrical energy (e.g., microwave heating, radiant heating, induction heating, the like), said electrical energy for heating the reactor may be derived from a source with low or no greenhouse gas emissions (e.g., solar energy, wind energy, hydropower energy, nuclear energy, the like, or any combination thereof).

### Catalyst

The catalyst used in the present disclosure may comprise a high entropy alloy catalyst, such a catalyst comprising a high entropy alloy, as previously described herein.

“High entropy alloy” as used herein, refers to a catalytic composition that has a mixed configuration entropy, S, of S≥12.47 J K⁻¹ mol⁻¹ and/or a catalytic composition comprising a metal alloy whose composition consists of five or more metal elements, with each element having a concentration of from 0.1 atomic percent (at %) to 50 at %.

Mixed configuration entropy, S, of a composition (e.g., an alloy) that includes more than one elemental species is typically calculated according to Equation 3 below.

$$S = - R \sum {x}_{i} ln ( {x}_{i} ) \qquad Equation 3$$

where R is the molar gas constant (equal to about 8.314 J K⁻¹ mol⁻¹), and xi is a mole fraction of an individual elemental species (e.g., an individual metal). Equation 1 may be simplified for alloys with an equimolar ratio of elements to Equation 4 below.

$$S = R ln n \qquad Equation 4$$

where n is the number of individual elemental species present in the alloy.

An alloy may be considered a high entropy alloy if the entropy, S, is greater than the entropy of mixed configuration of an equimolar compound with 5 species or more. If the number of equimolar elemental species present is 5, S=1.61R. Table 1 lists the example configurational entropy of equiatomic alloys with constituent elements up to and including 10. Thus, if the alloy has an entropy S, such that S≥1.5R, thus, equivalently, S≥12.47 J K⁻¹ mol⁻¹, the alloy can be considered a high entropy alloy.

TABLE 1
Configurational entropy of equiatomic alloys with constituent elements

| N | 1 | 2 | 3 | 4 | 5 | 6 | 7 | 8 | 9 | 10 |
|---|---|---|---|---|---|---|---|---|---|---|
| ΔS | 0 | 0.69R | 1.1R | 1.39R | 1.61R | 1.79R | 1.95R | 2.08R | 2.20R | 2.30R |

The high entropy alloys that are suitable for use in catalysts for hydrogen production in accordance with the present disclosure may comprise metals including, but not limited to, cobalt, chromium, iron, manganese, nickel, aluminum, molybdenum, copper, zinc, zirconium, ruthenium, rhodium, palladium, silver, tungsten, rhenium, iridium, platinum, gold, cerium, ytterbium, tin, the like, or any combination thereof. It should be noted that the high entropy alloy may comprise 5 or more (or 5, or 5 to 30, or 5 to 6, or 5 to 7, or 5 to 8, or 5 to 9, or 5 to 10, or 5 to 15, 5 to 20, or 5 to 25) suitable metals in any combination. Each metal in the high entropy alloy may comprise from 0.1 at % to 50 at % (or 0.1 at % to 20 at %, or 0.1 at % to 40 at %, or 0.1 at % to 25 at %, or 1 at % to 25 at %, or 5 at % to 35 at %) of the high entropy alloy.

The high entropy alloys may have a metal crystalline structure including, but not limited to, a face centered cubic (FCC), a body centered cubic (BCC), a hexagonal close packed (HCP) structure, the like, or any combination thereof. Furthermore, high entropy alloys of the present disclosure may have an amorphous structure or may have a structure comprising a combination of crystalline metal and amorphous components.

The inclusion of a high entropy alloy in the catalyst may provide additional features to the catalyst including increased activity and decreased adsorption energy. Without being bound by theory, it is believed that the presence of additional elements contributing to the high entropy of the high entropy catalyst allows for additional atomic arrangements on the surface of the catalyst, allowing for increased adsorption to the surface of the catalyst.

The high entropy alloy may be manufactured using synthesis in solid phase, liquid phase, gas phase, or any combination thereof. The synthesis method used may comprise any suitable method of manufacturing a high entropy alloy including, but not limited to, a wet-chemical method, sol-gel auto-combustion, spray pyrolysis, carbothermal shock synthesis, a hydrothermal method, pulse-laser ablation, mechanical milling, arc melting, induction melting, a metal spray technique, molecular beam epitaxy, atomic layer deposition, chemical vapor deposition, pulsed laser deposition, the like, or any combination thereof.

A catalyst support may be included in the catalyst. “Catalyst support” and grammatical variants thereof, as used herein, refer to a compound or material to which the catalyst is affixed for providing additional features. The catalyst support used in the present disclosure may comprise any suitable catalyst support material including, but not limited to, a metal, a metal oxide, a zeolite, carbon black, a secondary phase, the like, or any combination thereof. Suitable metal oxides may include, but are not limited to, Al₂O₃, SiO₂, MgO, TiO₂, Fe₃O₄, Fe₂O₃, ZrO₂, CeO₂, a lanthanide oxide (e.g., Er₂O₃), the like, or any combination thereof. The catalyst may comprise from 0.0001 at % to 80 at % (or 0.0001 at % to 20 at %, or 0.0001 at % to 40 at %) of the catalyst support. The catalyst support may be an internal catalyst support, an external catalyst support, or any combination thereof. An “internal catalyst support” as used herein refers to the catalyst support being embedded in the high entropy alloy structure. As a nonlimiting example, a catalyst with an internal catalyst support may comprise nanoparticles of silica where more than one nanoparticle of silica is on the surface of and/or within parts of a single catalyst particle, thus the silica nanoparticles comprise an internal catalyst support. An “external catalyst support” as used herein refers to a catalyst support that is external to the structure of the high entropy alloy. As a nonlimiting example, a catalyst with an external catalyst support may comprise an Au/TiO₂ catalyst, wherein the Au acts catalytically and the TiO₂ forms a large particle external to the Au, the TiO₂ thus acting as an external catalyst support.

The catalyst support, when added to the catalyst, may serve to increase the efficiency of the catalysis. The catalyst support may provide features to the catalyst such as, for example, increasing alloy dispersion, improving sintering resistance, increasing the rate of reactant adsorption, or any combination thereof. The catalyst support may additionally prevent impurity deposition (e.g., coke formation) on the surface of the catalyst, maintaining increased catalyst activity for a longer time duration. The catalyst support may function by interacting chemically, physically, or chemically and physically, with the other components of the catalyst, a reaction substrate, or any combination thereof.

A catalyst promotor may be included in the catalyst. “Catalyst promotor” and grammatical variants thereof, as used herein, refer to a compound provided with a catalyst for increasing the catalytic activity of the catalyst. The catalyst promotor used in the present disclosure may comprise any suitable catalyst promotor material including, but not limited to, a metal, a metal oxide, a secondary phase, the like, or any combination thereof. Suitable catalyst promotor materials may include, but are not limited to, an alkali metal (e.g., lithium, sodium, potassium, cesium, francium, or any combination thereof), an alkali earth metal (e.g., calcium, magnesium, barium, or any combination thereof), a transition metal (e.g., iron, cobalt, manganese, magnesium, nickel, molybdenum, copper, palladium, platinum, rhenium, or any combination thereof), a post-transition metal (e.g., aluminum, gallium, or any combination thereof), a cerium compound (e.g., cerium, a cerium oxide (e.g., Ce₂O₃, CeO₂, or any combination thereof), or any combination thereof), a lanthanide (e.g., lanthanum, neodymium, or any combination thereof), a metal oxide (e.g., MgO, Ca₂SiO₄, CaO, or any combination thereof), a germanium compound, the like, or any combination thereof. The catalyst promotor may comprise from 0.0001 at % to 50 at % (or 0.0001 at % to 20 at %, or 0.0001 at % to 40 at %) of the catalyst. The catalyst promotor may be an internal catalyst promotor, an external catalyst promotor, or any combination thereof. An “internal catalyst promotor” as used herein refers to wherein the catalyst promotor is embedded in the high entropy alloy structure. An “external catalyst promotor” as used herein refers to a catalyst promotor that is external to the structure of the high entropy alloy.

The catalyst promotor used in the present disclosure may serve as a chemical promotor, a structural promotor, or any combination thereof. When serving as a chemical promotor, the catalyst promotor may improve the efficiency of the catalyst by, without being bound by theory, altering the distribution of electrons at the surface of the catalyst. When serving as a structural promotor, the catalyst promotor may alter mechanical properties of the catalyst such as, for example, increasing sintering resistance. The catalyst promotor may also provide additional features such as increasing selectivity of the catalyst for a particular reactant. Without being bound by theory, the catalyst promotor may increase adsorption and chemisorption for a specific reactant at an active site of the catalyst, thus increasing selectivity. The catalyst promotor may also increase the durability of the catalyst.

It should be noted that in some embodiments the catalyst promotor may be a metal that in other embodiments may be a catalyst support, and yet in other embodiments may comprise the high entropy alloy. In other words, a single metal may provide catalytic activity in some embodiments, may serve as a catalyst promotor in other embodiments, and may serve as a catalyst support in yet other embodiments. Without being bound by theory, the function of a metal may be determined by other components in the catalyst and interactions with the other elements and compounds. By way of an illustrative nonlimiting example, in a first case a catalyst may comprise a high entropy alloy wherein the high entropy alloy comprises nickel, aluminum, magnesium, copper, and zinc, and wherein the catalyst further comprises zirconium as an internal catalyst promotor. Continuing the nonlimiting example, in a second case a catalyst may comprise a high entropy alloy wherein the high entropy alloy comprises nickel, aluminum, rhodium, silver, and palladium, and wherein the catalyst further comprises copper as an internal catalyst promotor. Continuing the nonlimiting example, in a third case a catalyst may comprise a high entropy alloy wherein the high entropy alloy comprises nickel, aluminum, zirconium, palladium, and zinc, and wherein the catalyst further comprises copper as a catalyst support. In the aforementioned nonlimiting example, copper may, depending on the embodiment, comprise the high entropy alloy, may serve as a catalyst promotor, or may serve as a catalyst support.

The catalysts described herein may also further comprise a secondary phase. The secondary phase may interact with any component of the catalyst and may provide features such as increased catalytic activity to the catalyst. As noted above, the secondary phase or portions thereof may serve as a catalyst promotor, a catalyst support, or any combination thereof. The secondary phase may comprise any suitable composition including, but not limited to, an intermetallic phase, a laves phase, a carbide phase, a boride phase, a boron-carbide phase, a nitride phase, a silicide phase, an aluminide phase, an oxide phase (e.g., MgO, Al₂O₃, or any combination thereof), a phosphide phase, a phosphate phase, a sulfide phase, a sulfate phase, a hydride phase, a hydrate phase, a carbonitride phase, a graphene phase, a graphene oxide phase, a nanotube phase, a graphite phase, or any combination thereof.

The catalyst of the present disclosure may comprise a high entropy alloy. The high entropy alloy may be present in the form of a plurality of particles. The plurality of high entropy alloy particles may be submicron-sized.

“Submicron-sized” and grammatical variants thereof, as used herein, refer to particles that may have an average dimension from about 1 nanometer (nm) to about 999 micrometers (μm).

High entropy alloy particles of the present disclosure may preferably have an average dimension of 1 nm to 15 μm (or 1 nm to 10 μm, or 1 nm to 999 nm, or 1 μm to 10 μm), or more preferably may have an average dimension of 1 nm to 10 μm, or 1 nm to 1 μm, or 1 nm to 100 nm, or even more preferably 1 nm to 50 nm, or most preferably 1 nm to 20 nm. Such preferable high entropy alloy particle sizes may allow for an optimized surface area for adsorption of reactants and consequent catalytic reactions according to the present disclosure. The average dimension of the plurality of high entropy alloy particles may be defined as the average width, length, height, diameter, or any combination thereof of a particle. The high entropy alloy particles may be of any shape including, but not limited to, spherical, cubic, triangular, oblong, irregular, or any combination thereof.

The catalyst itself (e.g., comprising a high entropy alloy and a catalyst support) may be present in the form of a plurality of particles as well, the plurality of catalyst particles each including one or more high entropy alloy particles. The plurality of catalyst particles may be submicron-sized. The plurality of catalyst particles may preferably have an average dimension from 1 nm to 500 μm (or 1 nm to 10 μm, or 1 nm to 999 nm, or 1 μm to 999 μm), or preferably may have an average dimension of 1 nm to 100 μm, or 50 nm to 125 μm, or 100 nm to 10 μm, or more preferably 100 nm to 5 μm, or most preferably 200 nm to 2 μm. Such preferable catalyst particle sizes may allow for an optimized surface area for catalytic reaction according to the present disclosure. The average dimension of the plurality of catalyst particles may be defined as the average width, length, height, diameter, or any combination thereof of a particle. The catalyst particles may be of any shape including, but not limited to, spherical, cubic, triangular, oblong, irregular, or any combination thereof. The plurality of catalyst particles may be formed to a catalyst bead, catalyst pellet, or any combination thereof in any suitable shape and size.

Without being bound by theory, such particle sizes (e.g., catalyst particles and/or high entropy alloy particles therein) may allow increased distance among particles and stronger interaction with the catalyst support, mitigating agglomeration of catalyst particles and/or metal sintering of high entropy alloys therein. Additionally, the optimized surface area provided by particle sizes disclosed herein may further promote reaction with high conversion efficiency and may provide volumetric space for carbon product and thus increase carbon tolerance of catalysts of the present disclosure. As a result, both activity and stability of catalysts of the present disclosure may be increased due to particle sizes disclosed herein.

The catalyst may further comprise a non-stick additive. The non-stick additive may prevent sticking of carbon and/or any other impurities formed during reaction to the catalyst, potentially maintaining the activity of the catalyst for an extended period of time, reducing the need to clean or replace the catalyst, thus reducing costs. The non-stick additive may comprise any suitable material including, but not limited to, magnesium silicate, borosilicate, borate, aluminum oxide, silicon dioxide, titanium oxide, zirconium oxide, the like, or any combination thereof.

The catalyst may preferably be a supported metal catalyst including a high entropy alloy. The high entropy alloy may preferably comprise at least five metals from iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, bismuth, the like, or any combination thereof. The high entropy alloy may preferably consist essentially of iron, cobalt, manganese, copper, and nickel, or the high entropy alloy may preferably consist essentially of iron, cobalt, manganese, molybdenum, and nickel. The high entropy alloy may preferably comprise metals therein in equimolar proportions. Example supported metal catalysts including a high entropy alloy may include, for example, but are not limited to, an Al₂O₃ supported FeCoMnNiCu catalyst, an Al₂O₃ supported FeCoMnNiMo catalyst, the like, or any combination thereof. Without being bound by theory, a supported high entropy alloy metal catalyst may provide increased catalyst efficiency and function due to factors including, but not limited to, the metal content and distribution with the catalyst, the composition of the catalyst support, pore size distribution, surface area, physical integrity, the like, or any combination thereof.

It should be noted that the catalyst may be further processed in order to modify features of the catalyst including, but not limited to, size, shape, the like, or any combination thereof. Example further processes for the catalyst will be known to one of ordinary skill in the art. As an example, the catalyst may be ball-milled, including ball-milled using zirconia media (e.g., yttria stabilized zirconia). Ball-milling of the catalyst may occur at any suitable revolution frequency and for any suitable length of time. Ball-milling of the catalyst may preferably occur at a revolution frequency of from 100 revolutions per minute (rpm) to 2000 rpm (or 100 rpm to 1500 rpm, or 100 rpm to 1200 rpm, or 1000 rpm to 1200 rpm, or about 1100 rpm). Ball-milling of the catalyst may preferably occur for a duration of from 1 day to 20 days (or 1 day to 8 days, or 1 day to 5 days, or 1 day to 4 days, or 1 day to 2 days, or about 1 day).

During reaction, catalyst may be housed in the reactor in any suitable fashion including, but not limited to, a catalyst bed (e.g., a fluidized bed), the like, or any combination thereof.

### Hydrocarbon

The hydrocarbon used for manufacturing of hydrogen may comprise any suitable hydrocarbon, for example, including, but not limited to, methane, ethane, propane, gasoline, kerosene, diesel fuel, residual oil, crude oil, the like, or any combination thereof.

The hydrocarbon may enter the reactor at any suitable pressure, temperature, and flowrate compatible with the reaction conditions of the reactor. If the hydrocarbon is introduced in gaseous form, the hydrocarbon may further comprise an inert carrier gas (e.g., nitrogen gas, argon, the like, or any combination thereof). While in the reactor, the hydrocarbon may be catalyzed by the catalyst to form the produced gas comprising hydrogen and the solid carbon.

### Hydrogen Gas

The hydrogen gas produced may be of any suitable purity including from 90 mol % to 99.99 mol % percent purity (40 mol % to 99.99 mol %, or 60 mol % to 99.99 mol %, or 80 mol % to 99.99 mol %, or 95 mol % to 99.99 mol %, or greater than 99.99 mol %). The hydrogen gas produced may be provided at any suitable temperature and pressure. The pressure and temperature of the hydrogen gas produced may be affected by the pressure and temperature of the reactor or any other unit described herein. The hydrogen gas produced may subsequently be directed to any suitable location including, but not limited to, a pipeline, a storage tank, a railcar tank, the like, or any combination thereof.

### Systems

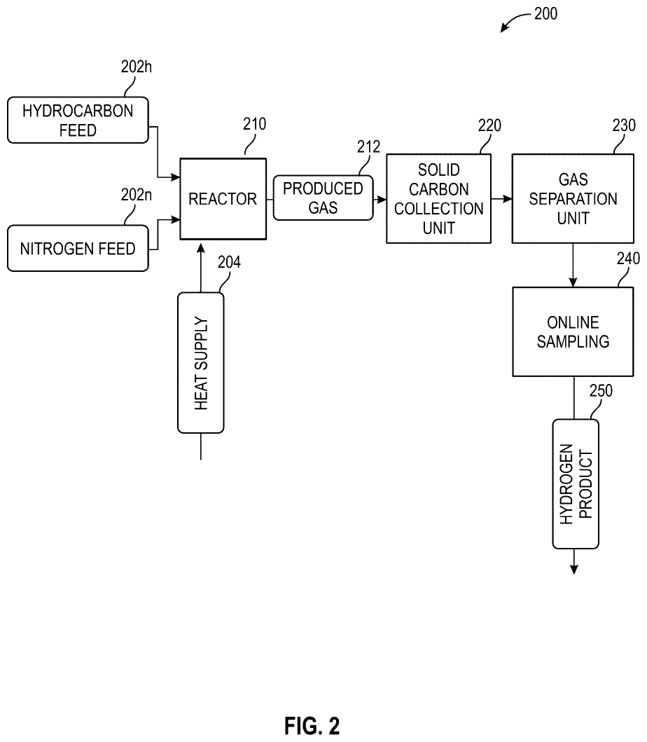

A diagram of nonlimiting example system of the present disclosure for production of hydrogen is shown in FIG. 2. System 200 includes a reactor 210 with a hydrocarbon feed 202h and a nitrogen feed 202n, as well as a heat supply 204 to the reactor 210. The reactor 210 may comprise catalyst therein, as discussed above. Following processing through the reactor 210, a produced gas stream 212 may enter one or more units for further processing, including a solid carbon collection unit 220 and gas separation unit 230. The system may, optionally, include online sampling equipment 240. Upon passing through the solid carbon collection unit 220, the gas separation unit 230, and the optional online sampling equipment 240, a hydrogen product stream 250 comprising hydrogen gas produced may be furnished. The hydrogen product stream 250 may be directed anywhere suitably as described above.

The overall system may have any suitable conversion efficiency, including, but not limited to, a conversion efficiency of from 20% to 99.9% (or 20% to 60%, or 60% to 99.9%, or greater than 99.9%). “Conversion efficiency,” as used herein, refers to a ratio of the actual conversion of a reactant to the theoretical stoichiometric conversion, and may be expressed as a percentage (%). Using methane (CH₄) as a nonlimiting example, if a 100% conversion efficiency is achieved, one mole of CH₄ can generate 2 moles of hydrogen H₂. Continuing the nonlimiting example, the methane conversion efficiency, MCE, may be calculated by Equation 5 below.

MCE=(R_{HYDROGEN}/2)/(R_{HYDROGEN}/2+R_{UNREACTED METHANE})*100 Equation 5

where R_{HYDROGEN} is the quantity of hydrogen generated in the outlet, and R_{UNREACTED METHANE} is the quantity of unreacted methane in the outlet. The system may include any suitable recycling streams and devices, which are not depicted herein, for further increasing the efficiency of conversion.

It additionally should be noted that methods and systems of the present disclosure may include operation of reactors described herein in any suitable manner, including any suitable configuration (e.g., in parallel, in series, the like, or a combination thereof) and including any suitable operational fashion (e.g., a continuous fashion, a batch-wise fashion, the like, or a combination thereof).

It should be appreciated that one skilled in the art should be able to, with the benefit of this disclosure, implement the methods and systems described above. It should be noted that additional nonlimiting components may be utilized in the methods and systems described above to produce hydrogen. Such additional components will be familiar to one having ordinary skill in the art and may include, but are not limited to, valves, pumps, joints, sensors, compressors, controllers, heat exchangers, sampling equipment (e.g., gas chromatography), the like, or any combination thereof.

### EXAMPLES

### Example 1

MET-5003, an unsupported metal alloy powder comprising 99.9% purity FeCoNiCrMn was used as a catalyst (available from Matexcel). The particle size of MET-5003 was 15 μm to 53 μm. About 20 g of MET-5003 powder was loaded into a vertical tubular reactor equipped with a quartz tube with 1 inch diameter and 530 mm length (22 mm ID×25 mm OD×530 mm length with #4 porosity Frit 200 mm from bottom). Subsequently, the quartz tube was closed on both ends by closures with suitable gas inlets and gas outlets. The system was purged with nitrogen gas to remove oxygen in the reactor environment. Subsequently, reactor heating was initiated to a reaction temperature of 700° C. with 10° C. per minute as the heating rate while maintaining nitrogen gas flow. When the reactor reached the desired reaction temperature, the gas flow was switched to methane with 20 mL/min as the flow rate.

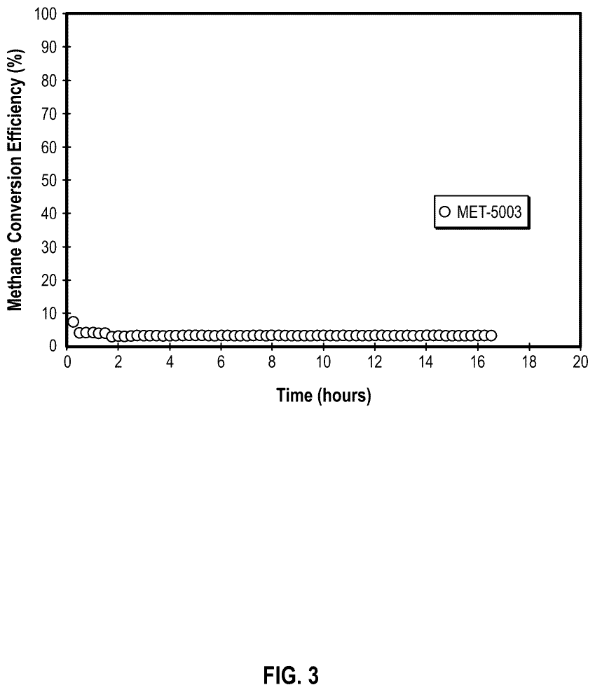

The exhaust gas comprising produced hydrogen, unreacted methane, and other possible produced gases was analyzed by online gas-chromatography. The methane conversion efficiency percentage (%) is shown in a graph in FIG. 3. As shown in FIG. 3, the methane conversion efficiency % is less than about 10%.

### Example 2

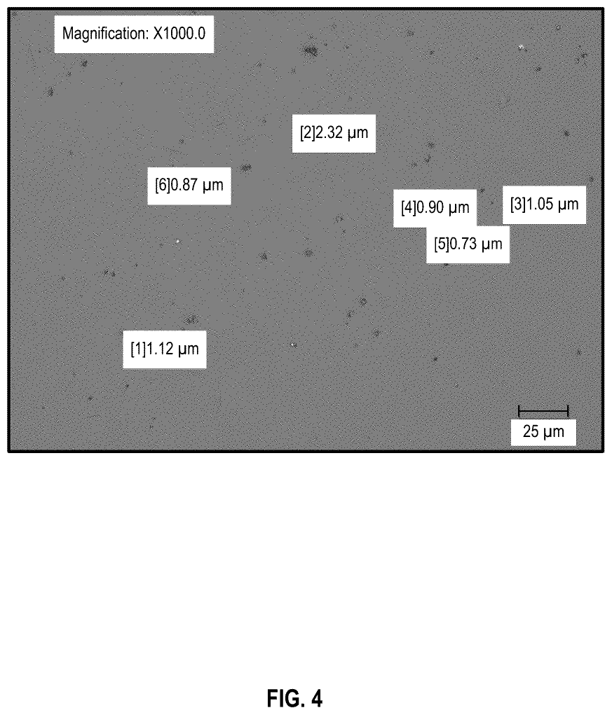

150 g of 3 mm zirconia media (e.g., yttria stabilized zirconia) and 200 g of 1 mm zirconia media were used to ball-mill 50 g of Al₂O₃, Fe, Co, Mn, Ni, Cu (the molar ratio of Al₂O₃:Fe:Co:Mn:Ni:Cu equal to 1:1:1:1:1:1) at room temperature (about 25° C.) for 2 days at 1100 rpm to form an Al₂O₃ supported FeCoMnNiCu catalyst. The ball-milled catalyst (Catalyst IE1) was separated using a 30 mesh sieve and catalyst samples were collected and examined under 1000× magnification, as shown in FIG. 4. The average particle size of particles of Catalyst IE1 was about 1 μm to about 2 μm.

About 20 g of Catalyst IE1 was loaded into a vertical tubular reactor equipped with a quartz tube with 1 inch diameter and 530 mm length (22 mm ID×25 mm OD×530 mm length with #4 porosity Frit 200 mm from bottom). The quartz tube was closed on both ends by closures with suitable gas inlets and gas outlets. The system was purged with nitrogen gas to remove oxygen in the reactor environment. Subsequently, reactor heating was initiated to a reaction temperature of 700° C. with 10° C. per minute as the heating rate while maintaining nitrogen gas flow. When the reactor reached the desired reaction temperature, the gas flow was switched to methane with a flow rate 20 mL/min.

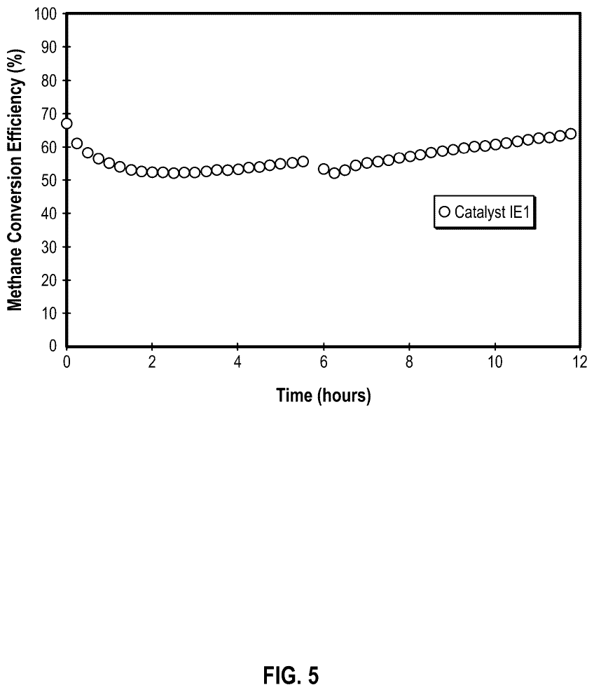

The exhaust gas comprising produced hydrogen, unreacted methane, and other possible produced gases was analyzed by online gas-chromatography. The methane conversion efficiency % is shown in a graph in FIG. 5. As shown in FIG. 5, the methane conversion efficiency % was between about 50% to about 65%.

### Example 3

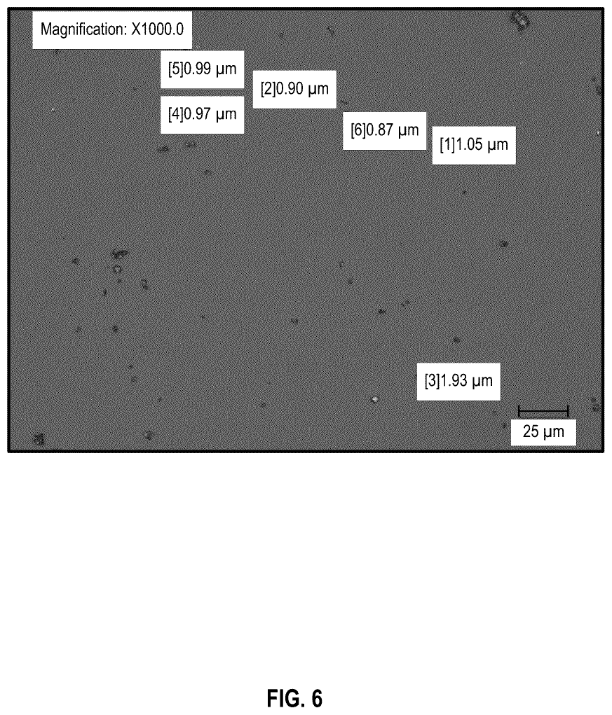

150 g of 3 mm zirconia media (e.g., yttria stabilized zirconia) and 200 g of 1 mm zirconia media were used to ball-mill 50 g of Al₂O₃, Fe, Co, Mn, Ni and Mo (the molar ratio of Al₂O₃:Fe:Co:Mn:Ni:Mo equal to 1:1:1:1:1:1) at room temperature (about 25° C.) for 2 days at 1100 rpm to form an Al₂O₃ supported FeCoMnNiMo catalyst. The ball-milled catalyst (Catalyst IE2) was separated using a 30 mesh sieve and catalyst samples were collected and examined under 1000× magnification, as shown in FIG. 6. The average particle size of particles of Catalyst IE2 was about 1 μm to 2 μm.

About 20 g of Catalyst IE2 was loaded into a vertical tubular reactor equipped with a quartz tube with 1 inch diameter and 530 mm length (22 mm ID×25 mm OD×530 mm length with #4 porosity Frit 200 mm from bottom). The quartz tube was closed on both ends by closures with suitable gas inlets and gas outlets. The system was purged with nitrogen gas to remove oxygen in the reactor environment. Subsequently, reactor heating was initiated to a reaction temperature of 700° C. with 10° C. per minute as the heating rate while maintaining nitrogen gas flow. When the reactor reached the desired reaction temperature, the gas flow was switched to methane with a flow rate 20 mL/min.

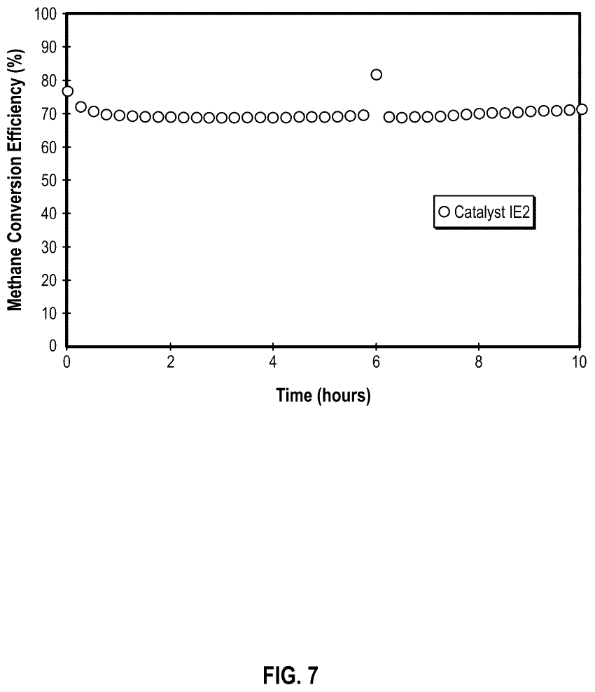

The exhaust gas comprising produced hydrogen, unreacted methane, and other possible produced gases was analyzed by online gas-chromatography. The methane conversion efficiency % is shown in a graph in FIG. 7. As shown in FIG. 7, the methane conversion efficiency % was about 70%.

Additionally, solid carbon byproducts were collected after the reactions of Examples 2 and 3 for Examples. The solid carbon byproduct included a mixture of black carbon, nanotubes, and nanofibers.

### Additional Embodiments

Embodiment 1. A method comprising: introducing a hydrocarbon to a reactor, wherein the reactor contains therein a catalyst, wherein the reactor is substantially absent of oxygen and water, wherein the catalyst comprises a high entropy alloy and a catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and reacting the hydrocarbon over the catalyst to produce solid carbon and hydrogen gas.

Embodiment 2. The method of Embodiment 1, wherein each metal of the high entropy alloy has a composition in the high entropy alloy from 0.1 at % (atomic percentage) to 50 at %.

Embodiment 3. The method of Embodiment 1 or 2, wherein the catalyst is located in a fluidized bed within the reactor.

Embodiment 4. The method of any one of Embodiments 1-3, further comprising: purging the reactor with an inert gas prior to introducing the hydrocarbon to remove the oxygen, the water, or a combination thereof.

Embodiment 5. The method of Embodiment 4, further comprising heating the reactor at least partially during purging of the reactor.

Embodiment 6. The method of Embodiment 5, wherein the reactor is heated by hydrocarbon heating, induction heating, plasma heating, microwave heating, solar furnace heating, radiative heating, or any combination thereof.

Embodiment 7. The method of Embodiment 6, wherein electrical energy for heating the reactor is sourced from a renewable generation source.

Embodiment 8. The method of any one of Embodiments 1-7, further comprising collecting the solid carbon.

Embodiment 9. The method of Embodiment 8, wherein the collecting uses a cyclonic separator.

Embodiment 10. The method of any one of Embodiments 1-9, further comprising separating the hydrogen gas from the solid carbon and remaining hydrocarbon.

Embodiment 11. The method of Embodiment 10, wherein the separating uses a separation membrane.

Embodiment 12. The method of any one of Embodiments 1-11, wherein the high entropy alloy is present in a form of a second plurality of particles, wherein the second plurality of particles has an average dimension from 1 nm to 500 nm.

Embodiment 13. The method of any one of Embodiments 1-12, wherein the first plurality of particles has an average dimension of catalyst from 0.2 μm to 5 μm.

Embodiment 14. The method of any one of Embodiments 1-13, wherein the catalyst support comprises Al₂O₃, and wherein the high entropy alloy comprises FeCoMnNiCu, FeCoMnNiMo, or any combination thereof.

Embodiment 15. The method of any one of Embodiments 1-13, wherein the high entropy alloy comprises iron, cobalt, manganese, nickel, and: a) molybdenum, b) copper, or c) molybdenum and copper; and wherein the iron, the cobalt, the manganese, the nickel, and the molybdenum and/or the copper are in equimolar concentration.

Embodiment 16. The method of any one of Embodiments 1-15, wherein a temperature of the reactor is from 300° C. to 1200° C.

Embodiment 17. A method comprising: purging a reactor with an inert gas so as to remove oxygen, water, or a combination thereof, wherein the inert gas comprises nitrogen, argon, or any combination thereof; introducing a hydrocarbon to the reactor, wherein the reactor contains therein a catalyst, wherein the catalyst comprises a high entropy alloy and an aluminum-based catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and reacting the hydrocarbon with the catalyst to produce solid carbon and produced gas, wherein the produced gas comprises hydrogen gas.

Embodiment 18. The method of Embodiment 17, wherein the hydrocarbon comprises methane, ethane, propane, gasoline, kerosene, diesel fuel, residual oil, crude oil, or any combination thereof.

Embodiment 19. A method comprising: introducing a hydrocarbon to a reactor, wherein the reactor contains therein a catalyst, wherein the reactor is substantially absent of oxygen and water, wherein the catalyst comprises a high entropy alloy and an aluminum-based catalyst support, wherein the catalyst is present in a form of a first plurality of particles, wherein the first plurality of particles is submicron-sized, wherein the high entropy alloy has an entropy, S, such that S≥12.47 J K⁻¹ mol⁻¹, and wherein the high entropy alloy consists essentially of iron, cobalt, manganese, nickel, and a) molybdenum, b) copper, or c) molybdenum and copper; and reacting the hydrocarbon over the catalyst to produce solid carbon and hydrogen gas.

Embodiment 20. The method of Embodiment 19, wherein the iron, the cobalt, the manganese, the nickel, and the molybdenum and/or the copper are in equimolar concentration.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains,” “containing,” “includes,” “including,” “comprises,” and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and are not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
introducing a hydrocarbon to a reactor,
wherein the reactor contains therein a catalyst,
wherein the reactor is substantially absent of oxygen and water,
wherein the catalyst comprises a high entropy alloy and a catalyst support,
wherein the catalyst is present in a form of a first plurality of particles,
wherein the first plurality of particles is submicron-sized,
wherein the high entropy alloy has an entropy, S, such that S≥12.47 J K⁻¹ mol⁻¹, and
wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and
reacting the hydrocarbon over the catalyst to produce solid carbon and hydrogen gas.

2. The method of claim 1, wherein each metal of the high entropy alloy has a composition in the high entropy alloy from 0.1 at % (atomic percentage) to 50 at %.

3. The method of claim 1, wherein the catalyst is located in a fluidized bed within the reactor.

4. The method of claim 1, further comprising:
purging the reactor with an inert gas prior to introducing the hydrocarbon to remove the oxygen, the water, or a combination thereof.

5. The method of claim 4, further comprising heating the reactor at least partially during purging of the reactor.

6. The method of claim 5, wherein the reactor is heated by hydrocarbon heating, induction heating, plasma heating, microwave heating, solar furnace heating, radiative heating, or any combination thereof.

7. The method of claim 6, wherein electrical energy for heating the reactor is sourced from a renewable generation source.

8. The method of claim 1, further comprising collecting the solid carbon.

9. The method of claim 8, wherein the collecting uses a cyclonic separator.

10. The method of claim 1, further comprising separating the hydrogen gas from the solid carbon and remaining hydrocarbon.

11. The method of claim 10, wherein the separating uses a separation membrane.

12. The method of claim 1, wherein the high entropy alloy is present in a form of a second plurality of particles, wherein the second plurality of particles has an average dimension from 1 nm to 500 nm.

13. The method of claim 1, wherein the first plurality of particles has an average dimension of catalyst from 0.2 μm to 5 μm.

14. The method of claim 1, wherein the catalyst support comprises Al₂O₃, and wherein the high entropy alloy comprises FeCoMnNiCu, FeCoMnNiMo, or any combination thereof.

15. The method of claim 1, wherein the high entropy alloy comprises iron, cobalt, manganese, nickel, and:
a) molybdenum,
b) copper, or
c) molybdenum and copper; and
wherein the iron, the cobalt, the manganese, the nickel, and the molybdenum and/or the copper are in equimolar concentration.

16. The method of claim 1, wherein a temperature of the reactor is from 300° C. to 1200° C.

17. A method comprising:
purging a reactor with an inert gas so as to remove oxygen, water, or a combination thereof, wherein the inert gas comprises nitrogen, argon, or any combination thereof;
introducing a hydrocarbon to the reactor,
wherein the reactor contains therein a catalyst,
wherein the catalyst comprises a high entropy alloy and an aluminum-based catalyst support,
wherein the catalyst is present in a form of a first plurality of particles,
wherein the first plurality of particles is submicron-sized,
wherein the high entropy alloy has an entropy, S, such that S≥12.47 J K⁻¹ mol⁻¹, and
wherein the high entropy alloy comprises at least five of: iron, cobalt, manganese, nickel, molybdenum, copper, zinc, titanium, chromium, vanadium, aluminum, gallium, ruthenium, rhodium, palladium, silver, indium, tungsten, rhenium, iridium, platinum, gold, and bismuth; and
reacting the hydrocarbon with the catalyst to produce solid carbon and produced gas,
wherein the produced gas comprises hydrogen gas.

18. The method of claim 17, wherein the hydrocarbon comprises methane, ethane, propane, gasoline, kerosene, diesel fuel, residual oil, crude oil, or any combination thereof.

19. A method comprising:
introducing a hydrocarbon to a reactor,
wherein the reactor contains therein a catalyst,
wherein the reactor is substantially absent of oxygen and water,
wherein the catalyst comprises a high entropy alloy and an aluminum-based catalyst support,
wherein the catalyst is present in a form of a first plurality of particles,
wherein the first plurality of particles is submicron-sized,
wherein the high entropy alloy has an entropy, S, such that S≥12.47 J K⁻¹ mol⁻¹, and
wherein the high entropy alloy consists essentially of iron, cobalt, manganese, nickel, and
a) molybdenum,
b) copper, or
c) molybdenum and copper; and
reacting the hydrocarbon over the catalyst to produce solid carbon and hydrogen gas.

20. The method of claim 19, wherein the iron, the cobalt, the manganese, the nickel, and the molybdenum and/or the copper are in equimolar concentration.
